(19) United States
(12) Patent Application Publication
(10) Pub. No.: US 2016/0297366 A1
(43) Pub. Date: Oct. 13, 2016

(54) PRINTED LED ANIMATED MIRROR TURN SIGNAL

(71) Applicant: FORD GLOBAL TECHNOLOGIES, LLC, Dearborn, MI (US)

(72) Inventors: Paul Kenneth Dellock, Northville, MI (US); Stuart C. Salter, White Lake, MI (US); Keith A. Hoelscher, Wayne, MI (US); Michael A. Musleh, Canton, MI (US); Harry Lobo, Canton, MI (US); Mary Beth Angotti, Canton, MI (US)

(21) Appl. No.: 14/684,518

(22) Filed: Apr. 13, 2015

(51) Int. Cl. B60R 1/12; B60Q 1/38

(52) U.S. Cl. CPC B60R 1/1207; B60Q 1/38

(57) ABSTRACT

A warning indicator system for a vehicle includes an indicator for providing visible signals within a reflective surface of a rear-vision mirror, operatively connected to at least a turn signal control system of the vehicle. The indicator is defined by a plurality of images activated sequentially to present an animated image to a viewer. The plurality of images is provided by a plurality of printed LED symbols disposed adjacent to one another within the rear-vision minor reflective surface. At least one processor operatively connected to the plurality of printed LED symbols and to the turn signal control system is configured to iteratively activate and deactivate the plurality of printed LED symbols in response to a signal from the turn signal control system. In this fashion, an animated turn signal indicator is provided within a reflective surface of a rear-vision minor such as a side minor of the vehicle.

### TECHNICAL FIELD

This disclosure relates generally to warning signals for motor vehicle. More particularly, the disclosure relates to an improved turn signal indicator for a vehicle side minor.

### BACKGROUND

It is known to provide minor-mounted turn signal indicators. When mounted in, e.g., a motor vehicle side minor, turn signal indicators provide a visible warning of an impending turn or lane change to other vehicles, as a supplement to the main turn signal lights typically mounted at least at each of the four corners of the vehicle and associated respectively with the brake light and/or headlight arrays of the vehicle. Often, turn signal indicators are provided to provide a visible signal within a reflective surface of the minor as a premium feature for a vehicle. That is, the signal or symbol indicative of an impending turn or lane change is configured to shine through the minor reflective surface.

As is also known, a steady or constantly actuated indicator signal such as a turn signal indicator is less likely to attract attention from other drivers than an intermittent signal. For that reason, most commonly the indicator signal will actuate intermittently or “blink.” This is because a flashing or blinking indicator signal is more likely to attract the attention of other motorists than a steady indicator.

Such conventional flashing indicator signals, while effective for their intended purpose, can be improved. The present disclosure satisfies this need in the art by providing an animated rear-vision mirror-mounted indicator such as a turn signal indicator which is relatively un-complex in design and which does not require bulky electronics for operation. To the eye, the described indicator appears to provide an animated or moving image within the rear-vision minor reflective surface, thus attracting the attention of surrounding motorists to a greater degree even than flashing or blinking indicators.

### SUMMARY

In accordance with the purposes and benefits described herein, in one aspect a turn signal warning indicator system is described. Printed LED technology is used to provide an animated turn signal warning indicator within a reflective surface of a rear-vision mirror that is cost-effective and that more effectively catches the attention of adjacent motorists than a conventional turn signal indicator. In embodiments, printed LED technology is used to provide adjacent or printed LED decals that are activated in sequence by a processor operatively linked to a vehicle turn signal control system. By the sequential activation, an animated turn signal indicator is provided through the rear-vision minor surface when the turn signal control system is activated.

In another aspect, rear-vision minor assemblies are described incorporating the above-described turn signal warning indicator system.

In the following description, there are shown and described embodiments of the disclosed animated turn signal indicator. As it should be realized, the device is capable of other, different embodiments and its several details are capable of modification in various, obvious aspects all without departing from the devices and methods as set forth and described in the following claims. Accordingly, the drawings and descriptions should be regarded as illustrative in nature and not as restrictive.

### BRIEF DESCRIPTION OF THE DRAWINGS

The accompanying drawing figures incorporated herein and forming a part of the specification, illustrate several aspects of the disclosed turn signal indicator, and together with the description serve to explain certain principles thereof. In the drawing:

FIG. 1 depicts a printed LED indicator according to the present disclosure;

FIG. 2 depicts a basic circuit for an animated printed LED warning indicator according to the present disclosure;

FIG. 3A depicts activation of a first printed LED decal of a plurality of printed LED decals disposed within a rear-vision minor reflective surface;

FIG. 3B depicts deactivation of the first printed LED decal of FIG. 3A and activation of a second printed LED decal of the plurality of printed LED decals;

FIG. 3C depicts deactivation of the second printed LED decal of FIG. 3B and activation of a third printed LED decal of the plurality of printed LED decals;

FIG. 3D depicts the animated turn signal indicator provided by the sequential activation and deactivation of each adjacent printed LED decals of the animated turn signal indicator of FIGS. 3A-3C;

FIG. 4A depicts an alternative embodiment of an animated turn signal indicator in a rear-vision minor reflective surface according to the present disclosure, showing activation of a first printed LED decal of a plurality of printed LED decals disposed within a rear-vision mirror reflective surface;

FIG. 4B depicts sequential overlapping activation of a first and a second printed LED decal of the plurality of printed LED decals;

FIG. 4C depicts sequential overlapping activation of a first, a second, and a third printed LED decal of the plurality of printed LED decals to provide an animated turn signal indicator; and

FIG. 5 graphically depicts shifting of blue light emitted by printed LEDs to reds and yellows by use of phosphor dyes.

Reference will now be made in detail to embodiments of the disclosed turn signal indicator, examples of which are illustrated in the accompanying drawing figures.

### DETAILED DESCRIPTION

To address the foregoing and other identified problems, the present disclosure describes a turn signal warning indicator provided by means of printed LED technology disposed within a reflective surface of a rear-vision minor. At a high level, the described warning indicator is configured to provide an animated indicator indicative of an impending turn or lane change through the reflective surface of a rear-vision mirror such as a vehicle side minor when the vehicle turn signal system is activated. The present disclosure and drawings primarily describe such a warning indicator provided in vehicle driver's side view mirror. However, the skilled artisan will readily recognize that the technology is equally suited to rear view minors, etc.

Preliminarily, vehicle turn signal systems are well-known in the art, and do not require extensive discussion herein. However, as is known such turn signal systems are typically activated by the vehicle driver, for example using controls mounted to a steering wheel column, to indicate to other motorists that a turn or lane change is imminent. On actuation of the turn signal control, conventionally a flashing signal is activated, most commonly one or more yellow lights blinking at the rear and front of the vehicle and also within the side minor, all on the side of the vehicle corresponding to the intended direction of the turn or lane change. Conventional systems use one or more LED lights to form the indicators.

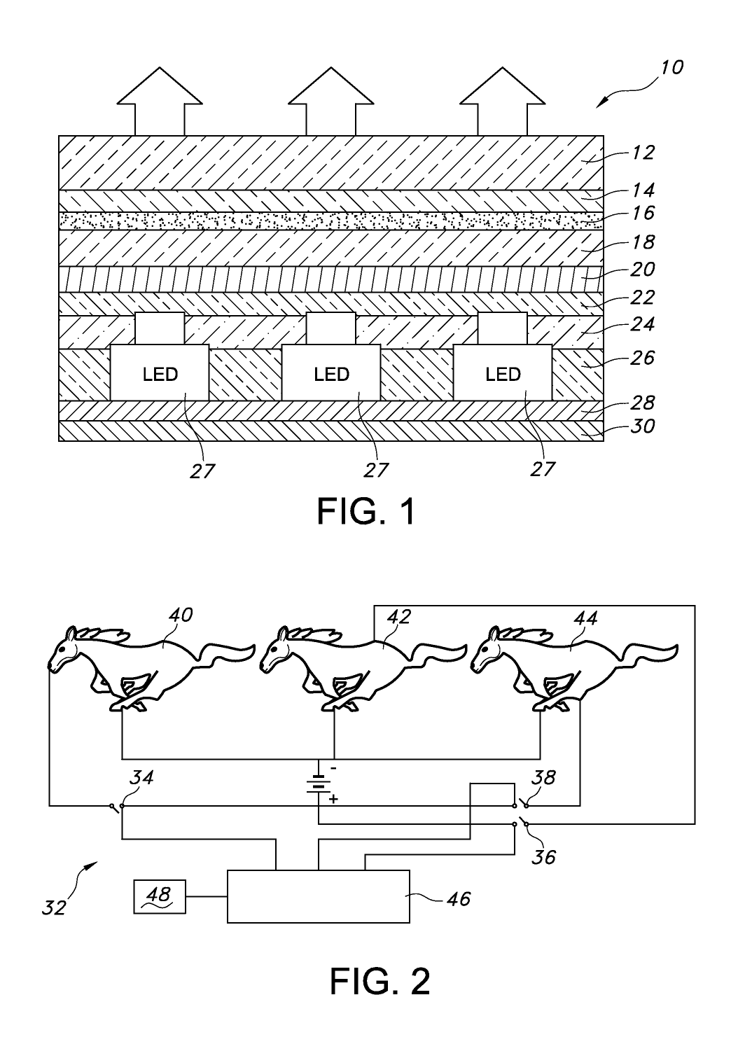

With reference to FIG. 1, in one embodiment a rear-vision minor assembly 10 is provided. The assembly 10 includes a glass or polymer outer layer 12, and an at least partially reflective coating 14 in combination providing a reflective mirror surface. A portion of the reflective coating 14 may be masked or etched out to allow light from the warning indicator to be visible through the outer layer 12. In alternative embodiments, the reflective coating 14 may be semi-transparent or partially reflective (similar to a two-way mirror) to hide the warning indicator when not activated.

An adhesive layer 16 may be included to adhere the warning indicator to a rear side of the reflective coating 14. This may be a coating of a suitable adhesive, two-sided adhesive tape, etc. A clear substrate layer 18 is interposed between the adhesive layer 16 and a printed LED design (see description below). This may be an optically clear plastic film, an optically clear adhesive, etc., providing a surface that can be printed on.

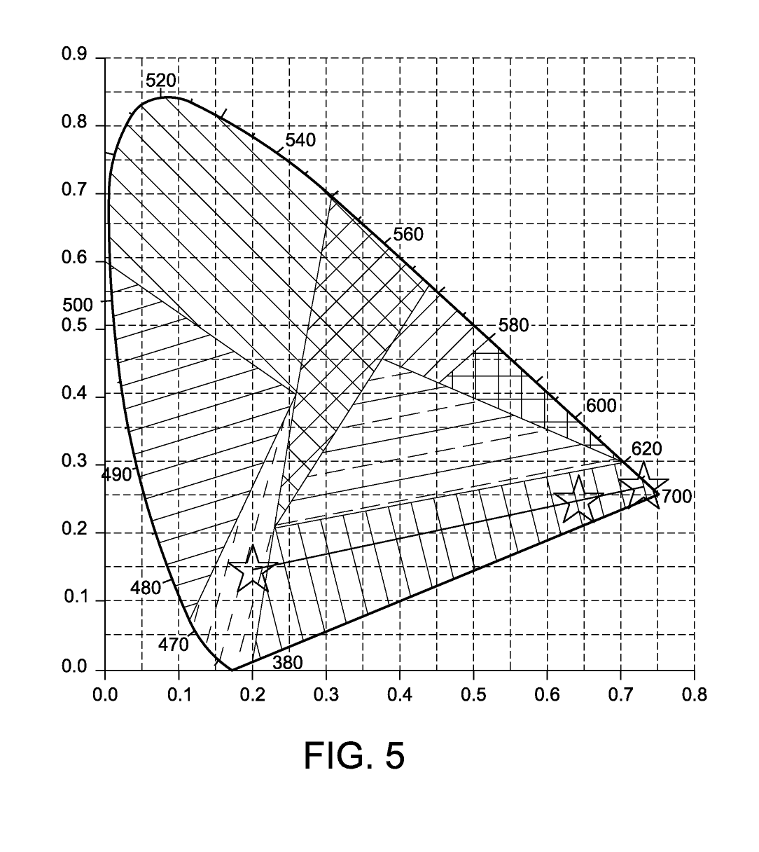

For the printed LED design which forms the warning indicator of the present disclosure, it will be appreciated that multiple colors of LED could be used to create desired designs as the technology advances. However, for reasons of cost effectiveness it is known to use printed LEDs emitting a blue color, overlaid with a suitable phosphor or other dye to alter the color of the light emitted by the printed LEDs. In one embodiment, rylene phosphor and/or YAG phosphor dyes are used to change the color emitted by portions of the printed LEDs. As is known in the art, rylene and other phosphor dyes can be applied to shift the blue light wavelengths emitted by blue LEDs to other desired color wavelengths, such as red and yellow wavelengths (see FIG. 5).

Referring back to FIG. 1, one or more layers 20 of a phosphor dye are included providing, in combination with the light emitted by blue printed LEDs, a desired color. The phosphor dye layers 20 are deposited on a transparent conductive layer 22, which is turn adjacent to one or more transparent dielectric layers 24. A random diode ink (RDI) layer or layers 26 containing a plurality of LEDs 27 suspended in the ink is printed on the conductive layer 22, to provide a desired pattern such as a chevron or other suitable shape. A conductive ink layer or layers 28 carries an electrical charge to the LEDs 27 included in the RDI layer 26. Finally, an insulating plastic film base 30 is provided to serve as a base substrate for the printed LED, protecting and sealing the assembly from water, chemicals, dirt, etc. This may be fabricated of any suitable material such as MYLAR, polyester, or any suitable plastic or polymer film to which the conductive ink layer 28 can adhere. In combination, these layers provide a vertically connected diode array that is randomly spaced, and define a shape which is visible as emitted light (see arrows) through the outer layer 12/reflective coating 14 when an electrical charge is supplied to the LEDs 27 of the RDI layer 26.

In an embodiment, the above construct is used to provide a rear-vision mirror-mounted warning indicator defined by a plurality of printed LED decals provided in any desired shape, such as in the embodiment depicted in FIGS. 2-4 a running horse. As depicted 3 printed LED decals are provided, although of course more or fewer decals could be included in accordance with the desired resolution of the animated indicator, the size of the rear-vision minor, etc.

With reference to FIG. 2, a circuit 32 is provided including switches 34, 36, 38 and printed LED decals 40, 42, 44. As provided, printed LED decals 40, 42, 44 each emit a same light color, typically blue for cost reasons as summarized above. By inclusion of phosphor dye layers 20 as described above, printed LED decals 40, 42, 44 are caused to emit light of a desired color, typically red or yellow since as is known those colors tend to best attract the attention of drivers and adjacent motorists. A processor 52 is configured to control operation of switches 34, 36, 38 and is operatively connected to a turn signal control system 48 of the vehicle (not shown).

In use, when switch 34 is closed by processor 46 in response to activation of the vehicle turn signal control system 48, printed LED decal 40 is activated. When switch 36 is closed by processor 46 in response to activation of the vehicle turn signal control system 48, printed LED decal 42 is activated. When switch 38 is closed by processor 46 in response to activation of the vehicle turn signal control system 48, printed LED decal 44 is activated.

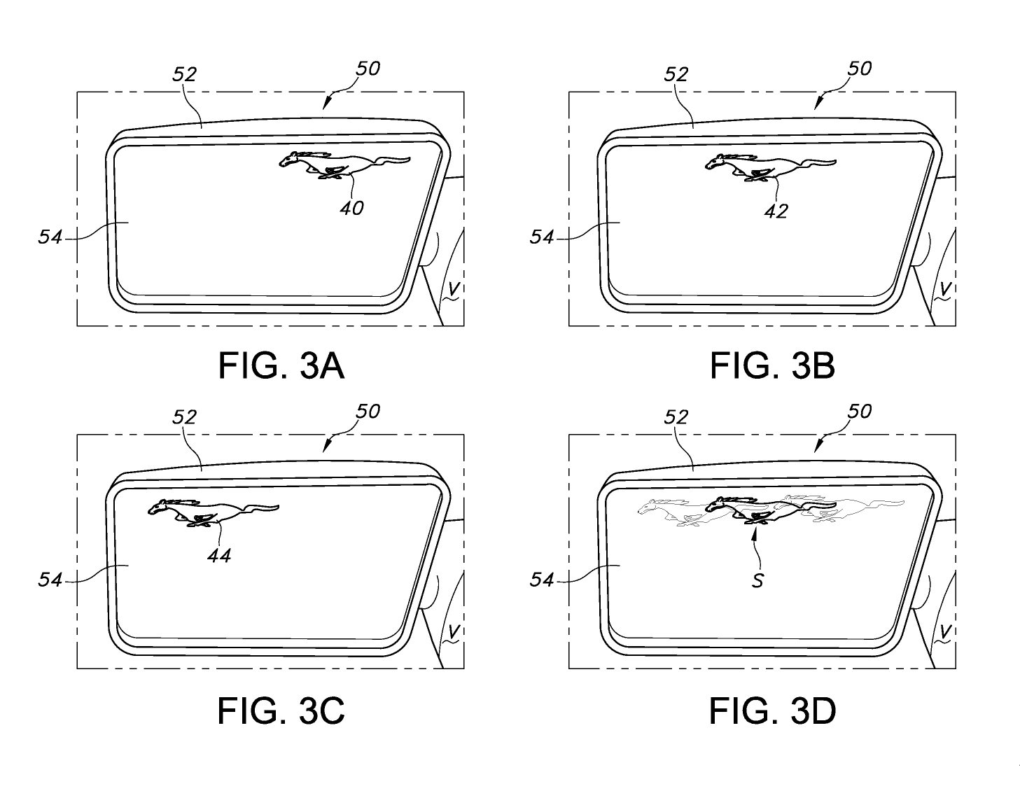

As will be appreciated, processor 46 may be programmed to activate/deactivate each printed LED decal 40, 42, 44 in any desired sequence. For example, as shown in FIGS. 3A-3D, a vehicle V side mirror assembly 50 is provided defined by a housing 52 and a reflective surface 54, and including a printed LED structure as described and shown in FIG. 1. A plurality of printed LED decals 40, 42, 44 are included as described above. A first LED decal 40 may be activated (FIG. 3A) by processor 46 (not shown) in response to a signal received from turn signal control system 48 (not shown). Then, after a predetermined time period (for example, a few milliseconds) first LED decal 40 may be deactivated, and second LED decal 42 may be activated (FIG. 3B). Then, after a predetermined time period (for example, a few milliseconds) second LED decal 42 may be deactivated and third LED decal 44 may be activated. This sequence proceeds iteratively to provide the appearance of an animated turn signal S, in the depicted embodiment being a running horse design (FIG. 3D).

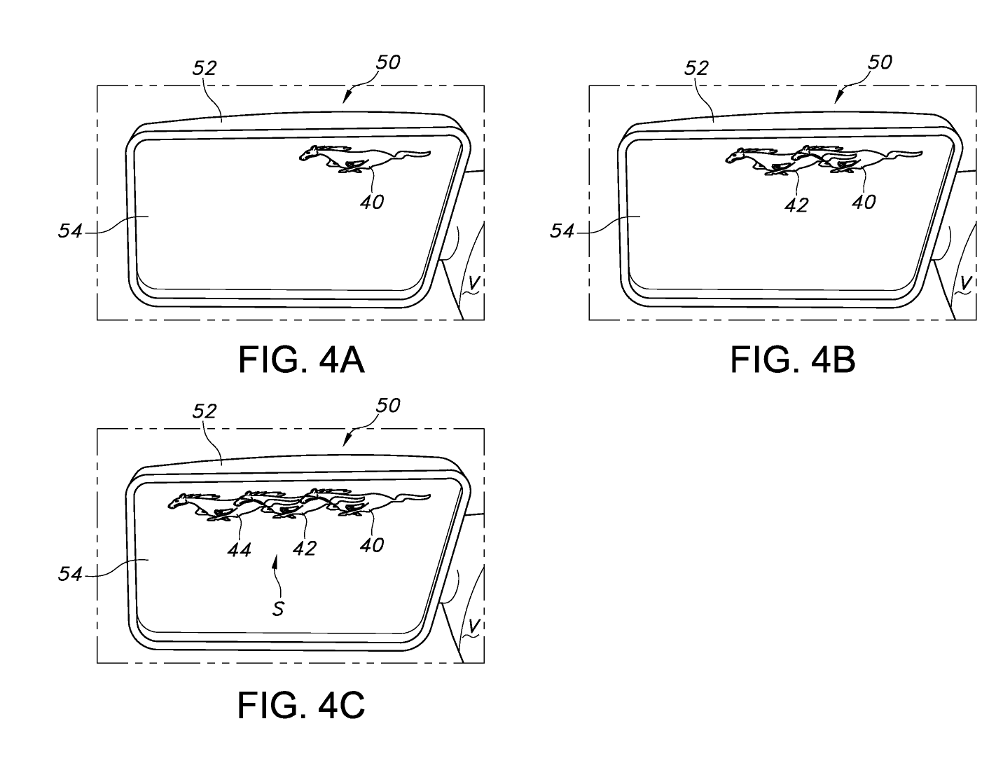

In an alternative embodiment (see FIGS. 4A-4C), a vehicle V side minor assembly 50 is provided substantially as shown in FIGS. 3A-3D. A plurality of printed LED decals 40, 42, 44 are included as described above. A first LED decal 40 may be activated (FIG. 4A) by processor 46 (not shown) in response to a signal received from turn signal control system 48 (not shown). Then, after a predetermined time period (for example, a few milliseconds) second LED decal 42 may be activated (FIG. 4B). Then, after a predetermined time period (for example, a few milliseconds) third LED decal 44 may be activated (FIG. 4C). Next, each printed LED decal 40, 42, 44 is deactivated, and the sequence starts over. This sequence proceeds iteratively to provide the appearance of an animated turn signal S.

In this manner, an animated turn signal warning indicator is provided. The warning indicator is visible through the rear-vision mirror reflective surface, which by use of printed LED technology provides a premium feature to the vehicle in a simple, cost-effective manner. Advantageously, by the feature of animation the indicator is significantly more likely to catch the attention of adjacent motorists than conventional turn signal indicators. Moreover, printed LED technology provides hundreds of LEDs spread in an even pattern. This provides a much smoother light pattern compared to conventional LED technology which typically uses arrays of 5-7 LEDs to create a turn signal indicator, creating a choppy surface to the pattern that does not lend itself to smooth animation.

Obvious modifications and variations are possible in light of the above teachings. For example, other sequences for activation of adjacent printed LED decals 40, 42, 44 by processor 46 are possible to create the perception of an animated turn signal S to a viewer, and are contemplated for use herein. All such modifications and variations are within the scope of the appended claims when interpreted in accordance with the breadth to which they are fairly, legally and equitably entitled.

1. A warning indicator system for a vehicle, comprising:
an indicator for providing visible signals within a reflective surface of a rear-vision mirror, operatively connected to at least a turn signal control system of the vehicle;
wherein the indicator comprises a plurality of images activated sequentially to present an animated image to a viewer, and
wherein the plurality of images are provided by a plurality of printed LED symbols disposed adjacent to one another within the rear-vision mirror reflective surface.

2. (canceled)

3. The system of claim 1, including at least one processor operatively connected to the plurality of printed LED symbols and to the turn signal control system.

4. The system of claim 3, wherein the processor is configured to iteratively activate and deactivate the plurality of printed LED symbols in response to a signal from the turn signal control system.

5. The system of claim 4, wherein the processor is configured to iteratively activate a next printed LED symbol after a preceding printed LED symbol is deactivated.

6. The system of claim 4, wherein the processor is configured to iteratively activate the plurality of printed LED symbols in overlapping sequence.

7. A rear-vision mirror assembly for a vehicle, comprising:
a housing holding a reflective surface; and
an indicator disposed within the reflective surface for providing visible signals, operatively connected to at least a turn signal control system of the vehicle;
wherein the indicator comprises a plurality of images activated sequentially to present an animated image to a viewer, and
wherein the plurality of images are provided by a plurality of printed LED symbols disposed adjacent to one another within the rear-vision mirror reflective surface.

8. (canceled)

9. The rear-vision mirror assembly of claim 7, including at least one processor operatively connected to the plurality of printed LED symbols and to the turn signal control system.

10. The rear-vision mirror assembly of claim 9, wherein the processor is configured to iteratively activate and deactivate the plurality of printed LED symbols in response to a signal from the turn signal control system.

11. The rear-vision mirror assembly of claim 10, wherein the processor is configured to iteratively activate a next printed LED symbol after a preceding printed LED symbol is deactivated.

12. The rear-vision mirror assembly of claim 10, wherein the processor is configured to iteratively activate the plurality of printed LED symbols in overlapping sequence.

13. A vehicle including the rear-vision mirror assembly of claim 7.

14. A side mirror turn signal assembly for a vehicle, comprising:
a housing holding a reflective surface; and
an animated turn signal indicator disposed within the reflective surface for providing visible signals through the reflective surface;
wherein the animated turn signal indicator is operatively connected to at least a turn signal control system of the vehicle and comprises a plurality of printed LED symbols disposed adjacent to one another within the reflective surface that are activated sequentially to present an animated image to a viewer.

15. The side mirror turn signal assembly of claim 14, further including at least one processor operatively connected to the plurality of printed LED symbols and to the turn signal control system.

16. The side mirror turn signal assembly of claim 15, wherein the processor is configured to iteratively activate and deactivate the plurality of printed LED symbols in response to a signal from the turn signal control system.

17. The side mirror turn signal assembly of claim 16, wherein the processor is configured to iteratively activate a next printed LED symbol after a preceding printed LED symbol is deactivated.

18. The rear-vision mirror assembly of claim 16, wherein the processor is configured to iteratively activate the plurality of printed LED symbols in overlapping sequence.

19. A vehicle including the side mirror turn signal assembly of claim 14.
